(19) United States
(12) Patent Application Publication
(10) Pub. No.: US 2026/0066512 A1
(43) Pub. Date: Mar. 5, 2026

(54) COAXIAL DOUBLE MOTOR FOR TUNING RF FILTER AND RF FILTER-TUNING APPARATUS USING THE SAME, AND METHOD THEREOF

(71) Applicant: ERANGTEK CO., LTD., Hwaseong-si Gyeonggi-do (KR)

(72) Inventors: Jae Bok LEE, Hwaseong-si (KR); Sang Hyo KANG, Hwaseong-si (KR); Sung Guyn KIM, Suwon-si (KR); Don Yong LEE, Sejong-si (KR); Joong Chang CHO, Hwaseong-si (KR)

(21) Appl. No.: 18/929,835

(22) Filed: Oct. 29, 2024

(30) Foreign Application Priority Data
Aug. 28, 2024 (KR) 10-2024-0115622

(51) Int. Cl. H01P 1/04; H01P 1/202

(52) U.S. Cl. CPC H01P 1/045; H01P 1/202

(57) ABSTRACT

Embodiments relate to a coaxial double motor for tuning an RF filter whose one motor is equipped with two coaxial shafts for controlling a tuning screwdriver for tightening a tuning screw of an RF filter and a nut driver for tightening a nut thereof and that is implemented to make one motor independently rotate one shaft for controlling a tuning screwdriver of an RF filter and the other shaft for controlling a nut driver thereof; and an RF filter tuning apparatus using the same and a method thereof.

### CROSS-REFERENCE TO RELATED APPLICATIONS

This application claims the priority of Korean Patent Application No. 10-2024-0115622 filed on Aug. 28, 2024, in the Korean Intellectual Property Office, the disclosure of which is incorporated herein by reference.

### FIELD OF THE INVENTION

The present invention relates to a coaxial double motor for tuning an RF filter and an RF filter-tuning apparatus using the same and a method thereof, and more particularly, to be furnished with one motor for controlling a tuning screwdriver for tightening a tuning screw of an RF filter and a nut driver for tightening a nut thereof.

In addition, the present invention relates to a coaxial double motor for tuning an RF filter, which enables one shaft for controlling a tuning screwdriver of an RF filter and the other shaft for controlling a nut driver thereof to rotate independently and an RF filter-tuning apparatus using the same and a method thereof.

### BACKGROUND OF THE INVENTION

An RF filter, as one of essential components of a wireless communication system, plays a role in passing only the frequency of a desired band among several input frequency components, and attenuating the other frequency signals and a variety of types and shapes of RF filters have been developed.

The pass band frequency of such an RF filter is determined by its inductance components and capacitance components and a work of adjusting the pass band frequency of such filter is called tuning.

The RF filters were produced through manual work by skilled workers using a tuning screw to complement structural characteristics such as processing and assembling tolerance, etc.

However, such manual work process requires considerable skill and shows dramatic difference in production depending on individuals'capabilities and whether to secure such skilled workers or not, leading the loss of cost competitiveness due to the increase of labor costs.

Besides, the different quality of all products was one of the big problems of the production process through manual work. To automate such labor-intensive production process, automatic tuning apparatuses have been studied.

For an instance, Korean Laid-Open Patent No. 10-2017-0040642 discloses an RF filter tuning system for automating all processes related to a tuning process required to adjust characteristics upon manufacturing an RF filter.

In the case, the structures of a motor rotating a tuning screw and a motor rotating a nut are complicated, and this is considered as a disadvantage.

### RELATED ART DOCUMENT

### Patent Document

(Patent Document 1) Korean Laid-Open Patent No. 10-2017-0040642 dated Apr. 13, 2017

### SUMMARY OF THE INVENTION

The object of the present invention is to provide a coaxial double motor for tuning an RF filter whose one motor is equipped with two coaxial shafts for controlling a tuning screwdriver for tightening a tuning screw of an RF filter and a nut driver for tightening a nut thereof and an RF filter tuning apparatus using the same and a method thereof.

The other object of the present invention is to provide a coaxial double motor for tuning an RF filter that is implemented to make one motor independently rotate one shaft for controlling a tuning screwdriver of an RF filter and the other shaft for controlling a nut driver thereof and an RF filter tuning apparatus using the same and a method thereof.

### BRIEF DESCRIPTION OF THE DRAWINGS

FIG. 1 is a drawing illustrating a coaxial double motor for tuning an RF filter and an RF filter tuning apparatus using the same in accordance with one example embodiment of the present invention. FIG. 1(a) represents that a commonly used stator of the coaxial double motor is permanent magnet, and FIG. 1(b) illustrates that the commonly used stators of the coaxial double motor are separated in length and are equipped as electromagnet.

FIG. 2 is a drawing illustrating that the screwdriver and the nut driver in FIG. 1 control a screw and a nut, respectively. FIG. 2(a) illustrates an initial state of an RF filter being unfixed due to the screwdriver and the nut driver separating from the screw and the nut, respectively. FIG. 2(b) represents that the RF filter is fixed by moving the screwdriver and the nut driver downward and making the screwdriver attached to the screw and the nut driver attached to the nut. FIG. 2(c) represents that tuning the RF filter is prepared by rotating only the nut driver and loosening the nut from the RF filter cover while the screw is fixed. FIG. 2(d) shows that the RF filter is tuned by rotating the screwdriver and controlling the screw to move upward or downward while the nut is loosened. FIG. 2(e) illustrates that tuning the RF filter is finished by rotating only the nut driver and fixing the nut on the RF filter cover while the screw is fixed and FIG. 2(f) represents that the RF filter is unfixed by moving the screwdriver and the nut driver upward and separating the screwdriver and the nut driver from the screw and the nut, respectively.

FIG. 3 is a flowchart showing a method of tuning an RF filter using a coaxial double motor for tuning an RF filter in accordance with one example embodiment of the present invention.

### DETAILED DESCRIPTION OF THE PREFERRED EMBODIMENTS

The specific example embodiments of the present invention are explained by referring to attached drawings below.

Upon the explanation of the present invention, terms such as “first,” “second,” etc. may be used to explain a variety of components but the components may not be limited by such terms. The terms are used only for the purpose of distinguishing one component from another. For example, a first component may be named as a second component without being beyond the scope of the rights of the present invention and similarly, even a second component may be named as a first one.

If it is mentioned that a component is connected or linked to another component, it may be understood that the component may be directly connected or linked to the another component but also a third component may exist in between them.

The terms used in this specification are used only to explain specific examples of embodiments and they are not intended to limit the present invention. Unless a context clearly indicates a different meaning, any reference to singular may include plural ones.

In this specification, terms such as include or equip are used to indicate that there are features, numbers, steps, operations, components, parts, or combinations thereof, and it can be understood that existence or one or more different features, numbers, steps, operations, components, parts, or combinations thereof are not precluded.

Besides, for clearer explanation, shapes, sizes, etc. of elements in drawings may be exaggerated.

Detailed explanation on a coaxial double motor for tuning an RF filter and an RF filter tuning apparatus using the same and a method thereof in accordance with one example embodiment of the present invention will be made by referring to the attached drawings.

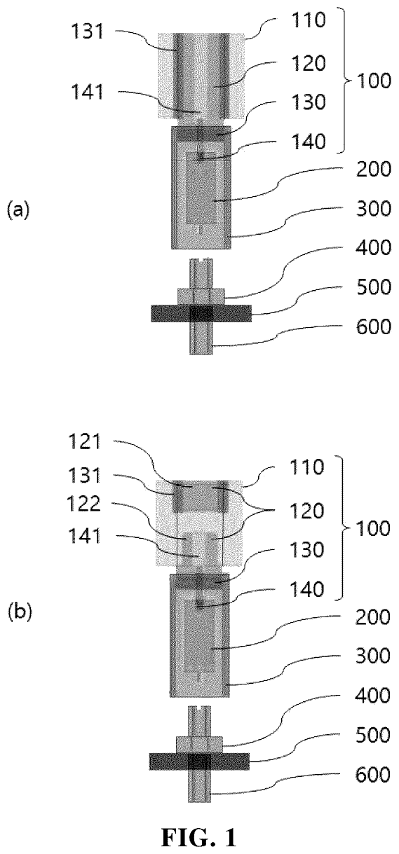

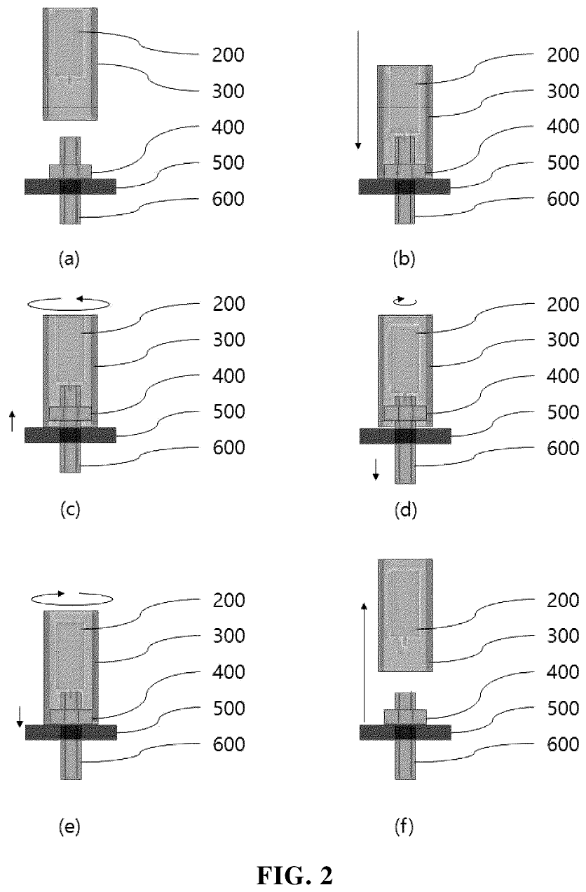

FIG. 1 is a drawing illustrating a coaxial double motor for tuning an RF filter and an RF filter tuning apparatus using the same in accordance with one example embodiment of the present invention. FIG. 1(a) represents that a commonly used stator of the coaxial double motor 100 is permanent magnet and FIG. 1(b) illustrates that commonly used stators of the coaxial double motor 100 are separated in length and are equipped as electromagnet. FIG. 2 is a detailed drawing to explain FIG. 1 in detail.

By referring to FIGS. 1 and 2, a coaxial double motor for tuning an RF filter and an RF filter tuning apparatus using the same in accordance with one example embodiment of the present invention is explained.

First of all, by referring to FIG. 1, a coaxial double motor 100 in accordance with one example embodiment of the present invention comprises a body 110, an inner shaft rotor 140 with central shaft within the body 110 rotating, and an outer shaft rotor 130 whose outer part rotates coaxially with the central shaft within the body 110.

Herein, the inner shaft rotor 140 and the outer shaft rotor 130 as rotors may have a stator 120 commonly available between the outer shaft rotor 130 and the inner shaft rotor 140.

At the time, when the stator 120 is equipped as permanent magnet, the outer shaft rotor 130 and the inner shaft rotor 140 may have an outer rotor 131 and an inner rotor 141 independently controlled with electromagnet, respectively. It is obvious that there exists a brush, not illustrated, to provide power to the outer rotor 131 and the inner rotor 141, but this may shorten the lifespan of the coaxial double motor 100 due to wear of the brush.

As the screwdriver 200 and the nut driver 300 require different torque respectively, the specifications of the outer rotor 131 and the inner rotor 141 respectively may be set up differently.

Meanwhile, a coaxial double motor 100 in accordance with another example embodiment of the present invention comprises a body 110, an inner shaft rotor 140 with central shaft within the body 110 rotating, and an outer shaft rotor 130 whose outer part rotates coaxially with the central shaft within the body 110.

Herein, the inner shaft rotor 140 and the outer shaft rotor 130 as rotors may have separate stators 120 commonly available between the outer shaft rotor 130 and the inner shaft rotor 140.

Moreover, the stators 120 as an outer stator 121 for controlling the outer shaft rotor 130 with electromagnet and an inner stator 122 for controlling the inner shaft rotor 140 with electromagnet may be separately placed back and forth coaxially.

At the time, the outer shaft rotor 130 and the inner shaft rotor 140 are equipped with an outer rotor 131 and an inner rotor 141 as permanent magnet, respectively, around the outer stator 121 and the inner stator 122.

Accordingly, since the rotors are permanent magnet, no separate brush is required. Therefore, the lifespan of the coaxial double motor 100 would not be shortened due to wear of the brush, and this is a benefit.

Meanwhile, as each of the screwdriver 200 and the nut driver 300 requires different torque, the specifications of the outer rotor 131, the inner rotor 141, the outer stator 121, and the inner stator 122, respectively, may be set up differently.

In addition, an RF filter tuning apparatus using a coaxial double motor for tuning an RF filter in accordance with the other example embodiment of the present invention comprises a coaxial double motor 100 equipped with an outer shaft rotor 130 and an inner shaft rotor 140, a screwdriver 200 of which rotation is controlled by the inner shaft rotor 140, and a nut driver 300 of which rotation is controlled by the outer shaft rotor 130.

Herein, the screwdriver 200 rotates a screw 600 penetrating RF filter cover 500 to control upward or downward movement of the screw 600, and the nut driver 300 rotates a nut 400 fixed on the RF filter cover 500 to control upward or downward movement of the nut 400. They can be performed so that the screw 600 can be fixed or rotated smoothly, and this is explained in detail in FIG. 2.

FIG. 2 is a drawing illustrating that the screwdriver 200 and the nut driver 300 in FIG. 1 control a screw 600 and a nut 400, respectively. FIG. 2(a) illustrates an initial state of an RF filter being unfixed due to the screwdriver 200 and the nut driver 300 separating from the screw 600 and the nut 400, respectively. FIG. 2(b) represents that the RF filter is fixed by moving the screwdriver 200 and the nut driver 300 downward and making the screwdriver 200 attached to the screw 600 and the nut driver 300 attached to the nut 400. FIG. 2(c) represents that tuning the RF filter is prepared by rotating only the nut driver 300 and loosening the nut 400 from the RF filter cover 500 while the screw 600 is fixed. FIG. 2(d) shows that the RF filter is tuned by rotating the screwdriver 200 and controlling the screw 600 to move upward or downward while the nut 400 is loosened. FIG. 2(e) illustrates that tuning the RF filter is finished by rotating only the nut driver 300 and fixing the nut 400 on the RF filter cover 500 while the screw 600 is fixed and FIG. 2(f) represents that the RF filter is unfixed by moving the screwdriver 200 and the nut driver 300 upward and separating the screwdriver 200 and the nut driver 300 from the screw 600 and the nut 400, respectively.

As can be seen in FIG. 2(a), in case of the RF filter tuning apparatus using the coaxial double motor for tuning an RF filter in accordance with the present invention, the screwdriver 200 and the nut driver 300 are initially separated from the screw 600 and the nut 400 respectively to keep the initial state of the RF filter being unfixed.

When the screwdriver 200 and the nut driver 300 are coaxial with the nut 400 and the RF filter cover 500, as can be seen in FIG. 2(b), the RF filter may be fixed by moving the screwdriver 200 and the nut driver 300 downward and making the screwdriver 200 attached to the screw 600 and the nut driver 300 attached to the nut 400.

At the time, as the screwdriver 200 does not match the groove of the screw 600, a process of turning the screwdriver 200 slowly to match it with the screw 600 may be required. At the time, damage may be caused by contact during the matching process. Therefore, the drop torque of the screwdriver 200 is required to be maintained to the minimum.

Besides, as the nut driver 300 does not match the groove of the nut 400, a process of turning the nut driver 300 slowly to match it with the nut 400 may be required. At the time, damage may be caused by contact during the matching process. Therefore, the drop torque of the nut 400 is required to be maintained to the minimum.

Meanwhile, to turn the screw 600, the nut 400 needs to be loosened from the RF filter cover 500, but as can be seen in FIG. 2(c), while the screw 600 is fixed, the nut 400 from the RF filter cover 500 is loosened by rotating only the nut driver 300 so that tuning the RF filter is prepared.

At the time, when the nut 400 rotates, the screw 600 must not rotate. Therefore, it must be performed that the nut 400 can rotate while the screw 600 is kept fixed all the time.

When the nut 400 is loosened and the rotation of the screw 600 becomes free, as can be seen in FIG. 2(d), the RF filter is tuned by rotating the screw 600 and controlling the screw 600 to move upward or downward while the nut 400 is loosened.

At the time, as the screw 600 moves up or down by rotation, the screwdriver 200 is equipped with a spring on its top so that the screwdriver 200 can perform upward or downward movement together with the screw 600 at the same time.

Then, as can be seen in FIG. 2(e), while the screw 600 is fixed, the nut 400 is fixed on the RF filter cover 500 by rotating only the nut driver 300 so that tuning the RF filter is finished.

At the time, when the screw 600 rotates together, the characteristics of the RF filter are changed. Therefore, caution is required.

Meanwhile, when the nut 400 is fixed on the RF filter cover 500 and it is fixed together with the screw 600, as can be seen in FIG. 2(f), the screwdriver 200 and the nut driver 300 are separated from the screw 600 and the nut 400, respectively, by moving the screwdriver 200 and the nut driver 300 upward and then the RF filter is unfixed.

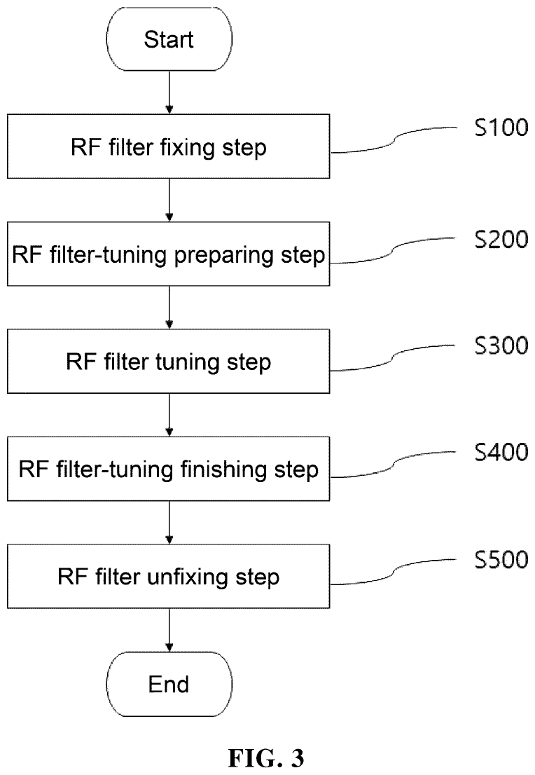

FIG. 3 is a flowchart showing a method of tuning an RF filter using a coaxial double motor for tuning an RF filter in accordance with one example embodiment of the present invention.

As can be seen in FIG. 3, a method of tuning an RF filter using a coaxial double motor for tuning an RF filter comprises: a RF filter fixing step of fixing an RF filter by moving a screwdriver 200 connected to an inner shaft rotor 140 of a coaxial double motor 100 and a nut driver 300 connected to an outer shaft rotor 130 thereof downward and making the screwdriver 200 attached to a screw 600 and a nut 400 attached to the nut driver 300 at S100; an RF filter-tuning preparing step of preparing to tune the RF filter by rotating only the nut driver 300 and loosening the nut 400 from RF filter cover 500 while the screw 600 is fixed at S200; an RF filter tuning step of tuning the RF filter by rotating the screw 600 and controlling the screw 600 to move upward or downward while the nut 400 is loosened at S300; an RF filter-tuning finishing step of finishing tuning the RF filter by rotating only the nut driver 300 and fixing the nut 400 on the RF filter cover 500 while the screw 600 is fixed at S400; and an RF filter unfixing step of unfixing the RF filter by moving the screwdriver 200 and the nut driver 300 upward and separating the screwdriver 200 and the nut driver 300 from the screw and the nut, respectively at S500.

According to a method of tuning an RF filter using a coaxial double motor for tuning an RF filter in accordance with the present invention, when the screwdriver 200 and the nut driver 300 are coaxial with the nut 400 and the RF filter cover 500, as can be seen in FIG. 2(a), the screwdriver 200 and the nut driver 300 are separated from the screw 600 and the nut 400, respectively, and are made to keep the initial state of the RF filter unfixed. After that, as can be seen in FIG. 2(b) showing the RF filter fixing step S100, the RF filter may be fixed by moving the screwdriver 200 and the nut driver 300 downward and making the screwdriver 200 attached to the screw 600 and the nut driver 300 attached to the nut 400.

Meanwhile, to rotate the screw 600, the nut 400 must be loosened from the RF filter cover 500. As can be seen in FIG. 2(c) representing the RF filter tuning preparing step S200, tuning the RF filter is prepared by rotating only the nut driver 300 and loosening the nut 400 from the RF filter cover 500 while the screw 600 is fixed. When the nut 400 is loosened and the rotation of the screw 600 becomes free, as can be seen in FIG. 2(d) representing the RF filter tuning step S300, the RF filter is tuned by rotating the screw 600 and controlling the screw 600 to move upward or downward while the nut 400 is loosened.

Then, as can be seen in FIG. 2(e) representing the RF filter-tuning finishing step S400, tuning the RF filter is finished by rotating only the nut driver 300 and fixing the nut 400 to the RF filter cover 500 while the screw 600 is fixed. When the nut 400 is fixed to the RF filter cover 500 and it is fixed together with the screw 600, as can be seen in FIG. 2(f) representing the RF filter unfixing step S500, the RF filter is unfixed by moving the screwdriver 200 and the nut driver 300 up and separating the screwdriver 200 and the nut driver 300 from the screw 600 and the nut 400, respectively. Since the detailed explanation has been made in FIG. 2, further detailed explanation is omitted.

Meanwhile, the coaxial double motor 100 for controlling the screwdriver 200 and the nut driver 300 comprises a body 110, an inner shaft rotor 140 with central shaft within the body 110 rotating, and an outer shaft rotor 130 whose outer part rotates coaxially with the central shaft within the body 110. As this has been explained in FIG. 1, further detailed explanation is omitted.

As seen above, the coaxial double motor for tuning an RF filter and the RF filter tuning apparatus using the same, and the method thereof in accordance with the present invention have a benefit that one motor is equipped with two coaxial shafts for controlling the tuning screwdriver for tightening the tuning screw of the RF filter and the nut driver for tightening the nut thereof. They have the other benefit of being implemented to make the one motor independently rotate a shaft for independently controlling the tuning screwdriver of the RF filter and the other shaft for controlling the nut driver thereof.

It will be understood by those skilled in the art that a variety of exemplary logistic blocks, modules, processors, means, circuits, and steps of algorithm explained with respect to the example embodiments of the present invention as disclosed herein can be implemented in electronic hardware and various forms of programs or design codes as indicated as software for convenience, or combination thereof. To clearly explain mutual compatibility between hardware and software, various exemplary components, blocks, modules, circuits, and steps have been generally explained above with respect to their functions. Whether the functions are implemented as hardware or software depends on restrictions in design given to specific applications and the whole system. Those skilled in the art may implement the functions explained in a variety of methods regarding each of the specific applications, but it could not be construed that implementation decisions are beyond the scope of the present invention.

A variety of embodiments proposed herein may be implemented as manufacturing articles using methods, apparatuses, or standard programming and/or engineering techniques. The term “manufacturing articles” include any computer-readable storage, accessible computer programs, carriers, or media. For example, computer readable storage media include magnetic media such as hard disk, floppy disk, and magnetic tape, optical media such as CD-ROM and DVD, smart cards, and flash memory drives such as EEPROM, cards, sticks, and key drives, but they are not limited to these. In addition, a variety of storage media presented herein include one or more apparatuses and/or other machine-readable media to store information.

It is to be understood that the specific order or hierarchical structure of steps in the presented processes is one example of exemplary approaches. Based on the priorities in design, it is to be understood that the specific order or hierarchical structure of steps in processes within the scope of the present invention may be rearranged. The attached method claims provide elements of various steps in the order of samples, but this does not mean that they are limited to the specific order or hierarchical structure presented.

Explanation on the presented examples of embodiments is given so that any person skilled in the art can use or implement the present invention. Various modifications to the example embodiments will be apparent to those skilled in the art, and the general principles defined herein may be applied to other example embodiments without going beyond the scope of the present invention. Therefore, the present invention is not be limited to the example embodiments presented herein, but should be construed in the widest scope consistent with the principles and novel characteristics specified herein.

What is claimed is:

1. A coaxial double motor for tuning an RF filter, comprising:
(a) a body;
(b) an inner shaft rotor with central shaft within the body rotating; and
(c) an outer shaft rotor whose outer part rotates coaxially with the central shaft within the body;
wherein the outer shaft rotor and the inner shaft rotor include a stator therebetween.

2. The motor of claim 1, wherein the stator is equipped as permanent magnet.

3. The motor of claim 2, wherein the outer shaft rotor and the inner shaft rotor have an outer rotor and an inner rotor independently controlled with electromagnet, respectively.

4. A coaxial double motor for tuning an RF filter, comprising:
(a) a body;
(b) an inner shaft rotor with central shaft within the body rotating; and
(c) an outer shaft rotor whose outer part rotates coaxially with the central shaft within the body;
wherein the outer shaft rotor and the inner shaft rotor include separate stators therebetween.

5. The motor of claim 4, wherein the stators as an outer stator for controlling the outer shaft rotor with electromagnet and an inner stator for controlling the inner shaft rotor with electromagnet are separately placed back and forth coaxially.

6. The motor of claim 5, wherein the outer shaft rotor and the inner shaft rotor are equipped with the outer rotor and the inner rotor as permanent magnet around the outer stator and the inner stator, respectively.

7. An RF filter-tuning apparatus using a coaxial double motor for tuning an RF filter, comprising:
(a) a coaxial double motor equipped with an outer shaft rotor and an inner shaft rotor;
(b) a screwdriver of which rotation is controlled by the inner shaft rotor; and
(c) a nut driver of which rotation is controlled by the outer shaft rotor.

8. The apparatus of claim 7, wherein an RF filter is fixed by moving the screwdriver and the nut driver downward and making the screwdriver attached to the screw and the nut driver attached to the nut.

9. The apparatus of claim 8, wherein tuning the RF filter is prepared by rotating only the nut driver and loosening the nut from RF filter cover while the screw is fixed.

10. The apparatus of claim 9, wherein the RF filter is tuned by rotating the screw and controlling the screw to move upward or downward while the nut is loosened.

11. The apparatus of claim 10, wherein tuning the RF filter is finished by rotating only the nut driver and fixing the nut on the RF filter cover while the screw is fixed.

12. The apparatus of claim 11, wherein the RF filter is unfixed by moving the screwdriver and the nut driver upward and separating the screwdriver and the nut driver from the screw and the nut, respectively.

13. A method of tuning an RF filter using a coaxial double motor for tuning an RF filter, comprising:
(a) an RF filter fixing step of fixing an RF filter by moving a screwdriver connected to an inner shaft rotor of a coaxial double motor and a nut driver connected to an outer shaft rotor thereof downward and making the screwdriver attached to a screw and the nut driver attached to a nut;
(b) an RF filter-tuning preparing step of preparing to tune the RF filter by rotating only the nut driver and loosening the nut from RF filter cover while the screw is fixed;
(c) an RF filter tuning step of tuning the RF filter by rotating the screw and controlling the screw to move upward or downward while the nut is loosened;
(d) an RF filter-tuning finishing step of finishing tuning the RF filter by rotating only the nut driver and fixing the nut on the RF filter cover while the screw is fixed; and
(e) an RF filter unfixing step of unfixing the RF filter by moving the screwdriver and the nut driver upward and separating the screwdriver and the nut driver from the screw and the nut, respectively.
